(19) United States
(12) Patent Application Publication
(10) Pub. No.: US 2014/0168136 A1
(43) Pub. Date: Jun. 19, 2014

(54) ELECTRONIC DEVICE WITH CAPACITIVE TOUCH SCREEN

(71) Applicant: HON HAI PRECISION INDUSTRY CO., LTD., (US)

(72) Inventor: KUO-HSIANG OUYANG, New Taipei (TW)

(73) Assignee: HON HAI PRECISION INDUSTRY CO., LTD., New Taipei (TW)

(21) Appl. No.: 13/831,890

(22) Filed: Mar. 15, 2013

(30) Foreign Application Priority Data
Dec. 17, 2012 (TW) 101147726

(51) Int. Cl. G06F 3/044

(52) U.S. Cl. CPC G06F 3/044
USPC 345/174

(57) ABSTRACT

An electronic device including a capacitive touch screen, a main circuit board, and a first grounding metal pad is provided. The capacitive touch screen includes a ground wire arranged along a peripheral edge of the capacitive touch screen. The first grounding metal pad is formed on the main circuit board. The ground wire electrically is connected to the first grounding metal pad and configured to conduct static electricity generated at the capacitive touch screen to the main circuit board through the first grounding metal pad.

### BACKGROUND

1. Technical Field

The present disclosure relates to electronic devices, and more particularly, to an electronic device with a capacitive touch screen.

2. Description of Related Art

Capacitive touch screens are widely used in electronic devices. A capacitive touch screen includes a conducting layer, comprising a material such as indium tin oxide (ITO). The capacitive touch screen is very sensitive and can be easily affected by static electricity existing in the surrounding environment. Improving the anti-interference ability of capacitive touch screens has become an important issue. Many capacitive touch screens include a ground wire arranged around the edge of the capacitive touch screen to solve the issue. Thus, static electricity surrounding the capacitive touch screen is conducted and discharged by connecting the ground wire to the main circuit board of the electronic device. However, during assembly, the ground wire needs to be welded to the main circuit board, which is troublesome and time consuming.

Therefore, there is a need to provide an electronic device with a capacitive touch screen to alleviate the limitations described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an electronic device with a capacitive touch screen in accordance with a first exemplary embodiment.

FIG. 2 is a partial, cross-sectional view of the electronic device of FIG. 1.

FIG. 3 is a schematic view of the capacitive touch screen of FIG. 1.

FIG. 4 is a schematic view showing the connection between a capacitive touch screen and a main circuit board of an electronic device, in accordance with a second exemplary embodiment.

### DETAILED DESCRIPTION

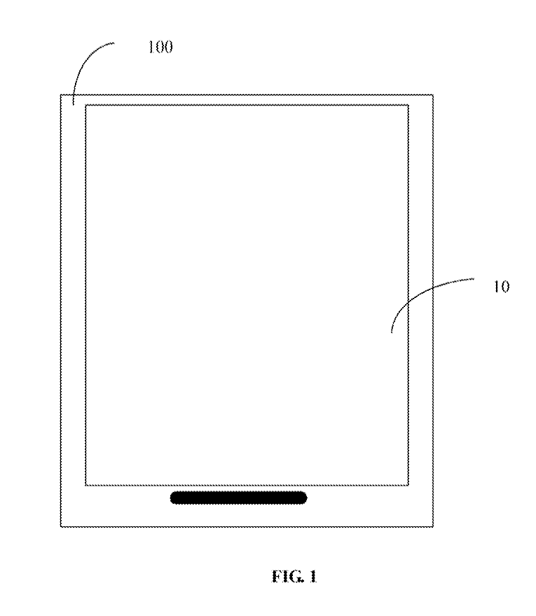

Referring to FIG. 1, an electronic device 100 with a capacitive touch screen 10 is provided. The electronic device 100 can be an electronic reader, a mobile phone, a digital photo frame, a personal digital assistant, or the like.

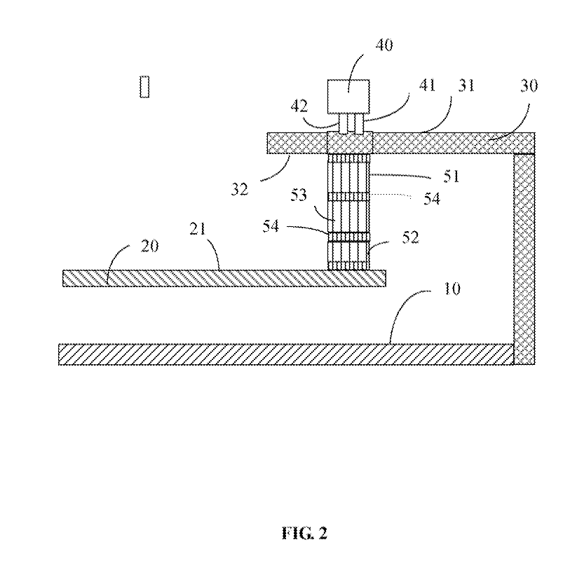

Referring to FIG. 2, the electronic device 100 further includes a main circuit board 20, a flexible printed circuit board 30, and a processor 40. The processor 40 includes an input pin 41 and an output pin 42. The flexible printed circuit board 30 is used for connecting the capacitive touch screen 10 to the main circuit board 20.

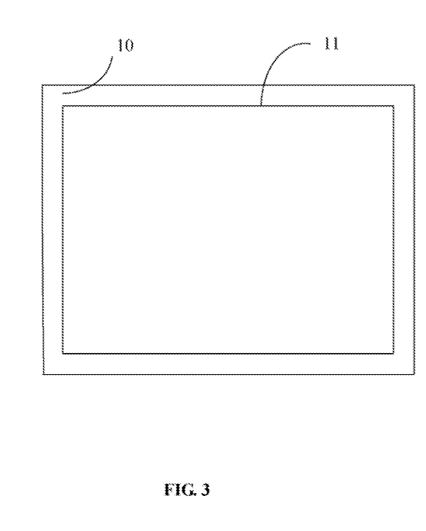

Referring to FIGS. 2 and 3, in the embodiment, the capacitive touch screen 10 includes a ground wire 11. The capacitive touch screen 10 is connected to the flexible printed circuit board 30. The ground wire 11 is also connected to the flexible printed circuit board 30. The ground wire 11 is a naked metal wire and is arranged along a peripheral edge of the capacitive touch screen 10 to conduct static electricity generated at the capacitive touch screen 10 to the main circuit board 20, thus static electricity of the capacitive touch screen 10 is discharged.

As shown in FIG. 2, the processor 40 is mounted on a first surface 31 of the flexible printed circuit board 30. The processor 40 is electronically connected to the flexible printed circuit board 30 by the input pin 41 and output pin 42. Thus, touch signals detected by the capacitive touch screen 10 are transmitted to the processor 40 by the flexible printed circuit board 30 and the input pin 41. The signals of the processor 40 are further transmitted to the flexible printed circuit board 30 by the output pin 42.

A first grounding metal pad 51 is arranged on a second surface 32 of the flexible printed circuit board 30 facing the main circuit board 20 and is positioned corresponding to the processor 40. A second grounding metal pad 52 is arranged on a first surface 21 of the main circuit board 20 facing the flexible printed circuit board 30 and is positioned corresponding to the first grounding metal pad 51. A third grounding metal pad 53 is sandwiched between the first grounding metal pad 51 and the second grounding metal pad 52. The three grounding metal pads 51, 52, 53 together support the flexible printed circuit board 30 and the processor 40. In the embodiment, the third grounding metal pad 53 is made of stainless steel. The third grounding metal pad 53 is electrically connected to the first grounding metal pad 51 and the second grounding metal pad 52 with conductive glue 54. The first grounding metal pad 51 is attached to the flexible printed circuit board 30 with conductive glue 54. The second grounding metal pad 52 is attached to the main circuit board 20 with conductive glue 54. In another embodiment, the first grounding metal pad 51 is integrally formed with the flexible printed circuit board 30, and the second grounding metal pad 52 is integrally formed with the main circuit board 20.

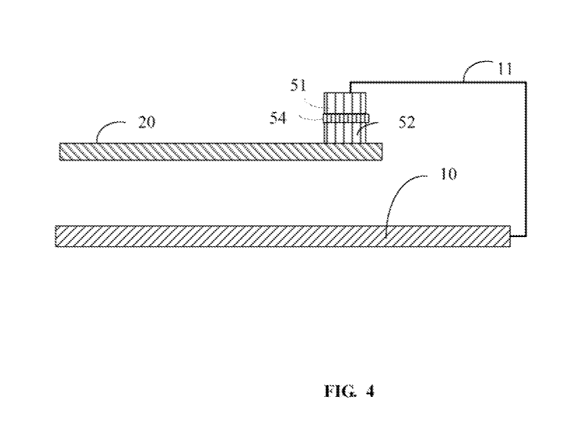

FIG. 4 shows another exemplary embodiment of the present disclosure. The ground wire 11 is attached to the main circuit board 20 by the first grounding metal pad 51 and the second grounding metal pad 52. That is to say, the free end of the ground wire 11 is attached to a first grounding metal pad 51. The second grounding metal pad 52 is mounted on a first surface 21 of the main circuit board 20 and is positioned corresponding to the ground wire 11. The first grounding metal pad 51 is attached to the second grounding metal pad 52 with conductive glue 54. Further, the first grounding metal pad 51 is integrally formed with the ground wire 11 and the second grounding metal pad 52 is integrally formed with the main circuit board 20. Thus, static electricity surrounding the capacitive touch screen 10 is conducted from the ground wire 11 to the main circuit board 20 through the first grounding metal pad 51 and the second grounding metal pad 52 and discharged.

In an alternative embodiment, the ground wire 11 is connected to the main circuit board 20 via the first grounding metal pad 51. That is to say, the ground wire 11 is integrally formed with the first grounding metal pad 51 and the first grounding metal pad 51 is attached to the main circuit board 20 with conductive glue.

The electronic device 100 of the present disclosure includes grounding metal pads sandwiched between the ground wire 11 and the main circuit board 20. The static electricity is conducted from the ground wire 11 to the main circuit board 20 to be discharged through the grounding metal pads. Because the grounding metal pad can be integrally formed with the ground wire 11 and the grounding metal pad is connected to the main circuit board via conductive glue, the traditional welding process is avoided, and the assembly for connecting the ground wire 11 to the main circuit board 20 provided by the present disclosure is more convenient and simple.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic device comprising:
a capacitive touch screen comprising a ground wire arranged along a peripheral edge of the capacitive touch screen;
a main circuit board; and
a first grounding metal pad formed on the main circuit board, the ground wire electrically connected to the first grounding metal pad,
wherein the ground wire is configured to conduct static electricity generated at the capacitive touch screen to the main circuit board through the first grounding metal pad.

2. The electronic device as described in claim 1, wherein the ground wire is integrally formed with the first grounding metal pad.

3. The electronic device as described in claim 2, wherein the first grounding metal pad is attached to the main circuit board with conductive glue.

4. The electronic device as described in claim 1, wherein a second grounding metal pad is sandwiched between the main circuit board and the first grounding metal pad, the first grounding metal pad is connected to the second grounding metal pad with conductive glue.

5. The electronic device as described in claim 1, wherein the ground wire is a naked metal wire.

6. An electronic device comprising:
a main circuit board;
a flexible printed circuit board;
a processor mounted on one surface of the flexible printed circuit board;
a capacitive touch screen comprising a ground wire arranged along a peripheral edge of the capacitive touch screen; and
a first grounding metal pad sandwiched between the flexible printed circuit board and the main circuit board;
wherein the ground wire is connected to the first grounding metal pad and is configured to conduct static electricity generated at the capacitive touch screen to the main circuit board through the flexible printed circuit board.

7. The electronic device as described in claim 6, wherein the first grounding metal pad is attached to the flexible printed circuit board and the main circuit board with conductive glue.

8. The electronic device as described in claim 6, wherein the electronic device further comprises a second grounding metal pad sandwiched between the first grounding metal pad and the main circuit board, the first grounding metal pad is attached to the second grounding metal pad with conductive glue.

9. The electronic device as described in claim 8, wherein the first grounding metal pad is integrally formed with the flexible printed circuited board and the second grounding metal pad is integrally formed with the main circuit board.

10. The electronic device as described in claim 8, wherein the capacitive touch screen further comprises a third grounding metal pad sandwiched between the first grounding metal pad and the grounding second grounding metal pad, the third grounding metal pad is attached to the first grounding metal pad and the second grounding metal pad with conductive glue.

11. The electronic device as described in claim 10, wherein the third grounding metal pad is made of stainless steel.

12. The electronic device as described in claim 6, wherein the ground wire is a naked metal wire.
